(19) United States
(12) Patent Application Publication
(10) Pub. No.: US 2024/0155701 A1
(43) Pub. Date: May 9, 2024

(54) METHOD AND DEVICE USED FOR WIRELESS COMMUNICATION

(71) Applicants: Jinfang ZHANG, Shanghai (CN); Xiaobo ZHANG, Shanghai (CN)

(72) Inventors: Jinfang ZHANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/386,258

(22) Filed: Nov. 2, 2023

(30) Foreign Application Priority Data
Nov. 3, 2022 (CN) 202211368270.9

(51) Int. Cl. H04W 76/10; H04W 76/30

(52) U.S. Cl. CPC H04W 76/10; H04W 76/30

(57) ABSTRACT

Method and device for wireless communications. A first node receives a first message, the first message configuring at least first RLC bearer; and receives a second message, the second message indicating that the at least first RLC bearer is/are a candidate of multiple radio bearers; and receives a third message, the third message indicating that the at least first RLC bearer is/are associated with a first radio bearer, the first radio bearer being one of the multiple radio bearers; and transmits a data unit of the first radio bearer via the at least first RLC bearer as a response to receiving the third message; herein, the second message is an RRC layer signaling, while the third message is a signaling of a protocol layer below the RRC layer. This application can ensure a fast reconfiguration of radio bearers and enhance the transmission adaptability.

### CROSS REFERENCE TO RELATED APPLICATIONS

This application claims the priority benefit of Chinese Patent Application No. 202211368270.9, filed on Nov. 3, 2022, the full disclosure of which is incorporated herein by reference.

### BACKGROUND

### Technical Field

The present application relates to methods and devices in wireless communication systems, and in particular to a method and device in wireless communications supporting flexible configurations to adapt to requests of traffic transmission.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 Plenary to standardize the NR. Some major application scenarios have already been taken into account when designing the 5G system in Release 15, and following versions shall not only consider the enhancement of the 5G system architecture but further enhance applications vertically to provide more flexible traffic matching, more robust transmission and more consistent user experience.

### SUMMARY

Inventors find through researches that due to the uncertainty of massive traffics and possible high-speed jitter in the future, the provision of fixed transmission configurations cannot ensure effective adaptability to traffic needs, because a potential inadequacy of resource configurations may cause a reduction in the quality of traffics; besides, excess resource configurations will result in more wastes and higher system complexity and maintenance cost.

To address the above problem, the present application provides a solution, that is, to configure a lower-layer transmission path for radio bearers in a flexible manner, so that the transmission path space and the system complexity can be reduced while gaining the advantage in traffic adaptability and transmission robustness. In the case of no conflict, the embodiments of a first node and the characteristics in the embodiments may be applied to a second node, and vice versa. What's more, the embodiments in the present application and the characteristics in the embodiments can be arbitrarily combined if there is no conflict. Furthermore, though originally targeted at a Uu air interface, the present application is also applicable to a PC5 air interface. Furthermore, the present application is designed targeting terminal-base station scenario, but can be extended to relay-base station communications, where similar technical effects can be achieved. Additionally, the adoption of a unified solution for various scenarios, including but not limited to V2X and terminal-base station communications, contributes to the reduction of hardcore complexity and costs. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first message, the first message configuring at least first RLC bearer; and
receiving a second message, the second message indicating that the at least first RLC bearer is/are a candidate of multiple radio bearers; and
receiving a third message, the third message indicating that the at least first RLC bearer is/are associated with a first radio bearer, the first radio bearer being one of the multiple radio bearers; and
transmitting a data unit of the first radio bearer via the at least first RLC bearer as a response to receiving the third message;
herein, the second message is an RRC layer signaling, while the third message is a signaling of a protocol layer below the RRC layer.

In one embodiment, after receiving a second message and before receiving a third message, none of the at least said first Radio Link Control (RLC) bearer is associated with any radio bearer among the multiple radio bearers.

In one embodiment, after receiving a second message and before receiving a third message, the at least first RLC bearer is/are pending.

In one embodiment, after receiving a second message and before receiving a third message, the at least first RLC bearer is/are not activated.

In one embodiment, the multiple radio bearers have the same Quality of Service (QoS).

In one embodiment, the multiple radio bearers have different QoSs.

In one embodiment, the multiple radio bearers belong to a same type of radio bearers.

In one embodiment, an RLC bearer is a lower layer part of a radio bearer, which includes RLC and Logical CHannel (LCH).

In one embodiment, making at least first RLC bearer a candidate of multiple radio bearers in the above method can reduce the RLC bearer space, which thus reduces the maintenance cost.

In one embodiment, the above method can effectively ensure the flexibility.

In one embodiment, the above method can effectively enhance the traffic adaptability of channels.

In one embodiment, the above method can flexibly reconfigure radio bearers.

In one embodiment, the above method can quickly reconfigure radio bearers.

According to one aspect of the present application, comprising:
transmitting a fourth message, the fourth message indicating a state of the first radio bearer;
herein, the fourth message is used for triggering the third message.

In one embodiment, the above method effectively supports uplink transmission.

According to one aspect of the present application, comprising:
receiving a fifth message, the fifth message configuring a second RLC bearer to be associated with the first radio bearer; and
transmitting a data unit of the first radio bearer via the second RLC bearer as a response to receiving the fifth message;
herein, the fifth message is an RRC layer message; reception of the fifth message is earlier than reception of the third message.

According to one aspect of the present application, comprising:
the third message indicating one of a Packet Data Convergence Protocol (PDCP) duplication or a data volume threshold; when the third message indicates the PDCP duplication, the at least first RLC bearer is/are used for PDCP duplication; when the third message indicates the data volume threshold, the at least first RLC bearer is/are used for a splitSecondaryPath.

In one embodiment, the above method can enhance the transmission robustness.

In one embodiment, the above method can enhance the transmission rate.

According to one aspect of the present application, comprising:
the third message is used for deactivating the second RLC bearer.

In one embodiment, the above method can switch the RLC bearer rapidly to shorten the interruption time during transmission and thus enhance the efficiency.

According to one aspect of the present application, comprising:
an RLC mode used by the at least first RLC bearer being identical to an RLC mode used by the second RLC bearer.

In one embodiment, the above method can provide consistent user experience.

According to one aspect of the present application, comprising:
the at least first RLC bearer and the second RLC bearer belonging to a same cell group, or, the at least first RLC bearer and the second RLC bearer belonging to different cell groups.

In one embodiment, the above method can make full use of radio resources.

The present application provides a method in a second node for wireless communications, comprising:
transmitting a first message, the first message configuring at least first RLC bearer; and
transmitting a second message, the second message indicating that the at least first RLC bearer is/are a candidate of multiple radio bearers; and
transmitting a third message, the third message indicating that the at least first RLC bearer is/are associated with a first radio bearer, the first radio bearer being one of the multiple radio bearers; and
transmitting a data unit of the first radio bearer via the at least first RLC bearer after transmitting the third message;
herein, the second message is an RRC layer signaling, while the third message is a signaling of a protocol layer below the RRC layer.

According to one aspect of the present application, comprising:
receiving a fourth message, the fourth message indicating a state of the first radio bearer;
herein, the fourth message is used for triggering the third message.

According to one aspect of the present application, comprising:
transmitting a fifth message, the fifth message configuring a second RLC bearer to be associated with the first radio bearer; and
transmitting a data unit of the first radio bearer via the second RLC bearer after transmitting the fifth message;
herein, the fifth message is an RRC layer message; transmission of the fifth message is earlier than transmission of the third message.

According to one aspect of the present application, comprising:
the third message indicating one of a Packet Data Convergence Protocol (PDCP) duplication or a data volume threshold; when the third message indicates the PDCP duplication, the at least first RLC bearer is/are used for PDCP duplication; when the third message indicates the data volume threshold, the at least first RLC bearer is/are used for a splitSecondaryPath.

According to one aspect of the present application, comprising:
the third message being used for deactivating the second RLC bearer.

According to one aspect of the present application, comprising:
an RLC mode used by the at least first RLC bearer being identical to an RLC mode used by the second RLC bearer.

According to one aspect of the present application, comprising:
the at least first RLC bearer and the second RLC bearer belonging to a same cell group, or, the at least first RLC bearer and the second RLC bearer belonging to different cell groups.

The present application provides a first node for wireless communications, comprising:
a first receiver, which receives a first message, the first message configuring at least first RLC bearer; and receives a second message, the second message indicating that the at least first RLC bearer is/are a candidate of multiple radio bearers; and receives a third message, the third message indicating that the at least first RLC bearer is/are associated with a first radio bearer, the first radio bearer being one of the multiple radio bearers; and
a first processor, which transmits a data unit of the first radio bearer via the at least first RLC bearer as a response to receiving the third message;
herein, the second message is an RRC layer signaling, while the third message is a signaling of a protocol layer below the RRC layer.

The present application provides a second node for wireless communications, comprising:
a first transmitter, which transmits a first message, the first message configuring at least first RLC bearer; and transmits a second message, the second message indicating that the at least first RLC bearer is/are a candidate of multiple radio bearers; and transmits a third message, the third message indicating that the at least first RLC bearer is/are associated with a first radio bearer, the first radio bearer being one of the multiple radio bearers; and
a second processor, which transmits a data unit of the first radio bearer via the at least first RLC bearer after transmitting the third message;
herein, the second message is an RRC layer signaling, while the third message is a signaling of a protocol layer below the RRC layer.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of signal transmission of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of hardcore modules in a communication device according to one embodiment of the present application.

FIG. 5 illustrates a flowchart of a radio signal transmission according to one embodiment of the present application.

FIG. 6 illustrates a schematic diagram of at least first RLC bearer, a second RLC bearer and a first radio bearer according to one embodiment of the present application.

FIG. 7 illustrates another schematic diagram of at least first RLC bearer, a second RLC bearer and a first radio bearer according to one embodiment of the present application.

FIG. 8 illustrates a schematic diagram of at least first RLC bearer, a second RLC bearer, a first radio bearer and a cell group according to one embodiment of the present application.

FIG. 9 illustrates a schematic diagram of a format of a third message according to one embodiment of the present application.

FIG. 10 illustrates a structure block diagram of a processing device in a first node according to one embodiment of the present application.

FIG. 11 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

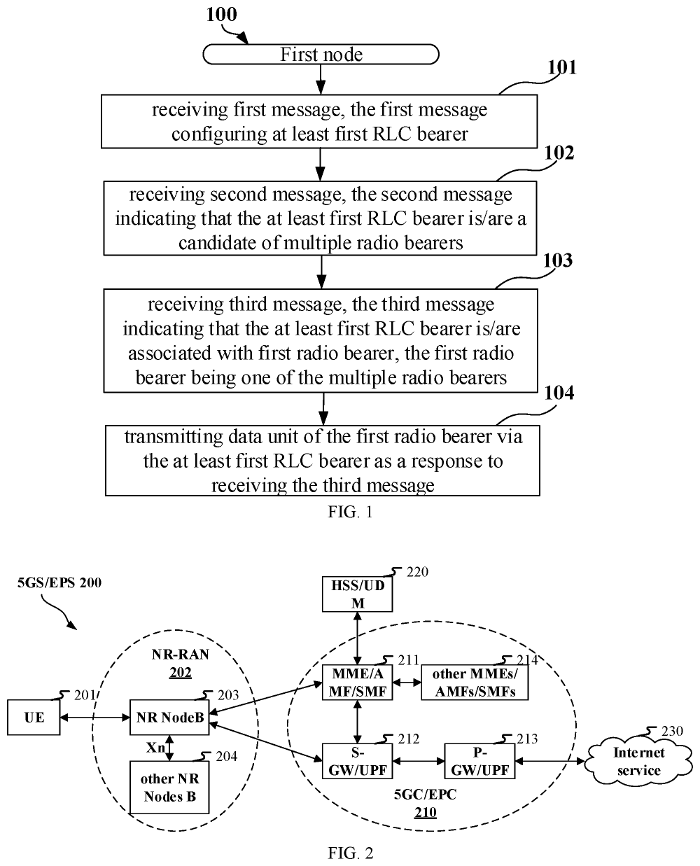

Embodiment 1 illustrates a flowchart of signal transmission of a first node according to one embodiment of the present application, as shown in FIG. 1.

In Embodiment 1, a first node 100 receives a first message in step 101, the first message configuring at least first RLC bearer; and receives a second message in step 102, the second message indicating that the at least first RLC bearer is/are a candidate of multiple radio bearers; and receives a third message in step 103, the third message indicating that the at least first RLC bearer is/are associated with a first radio bearer, the first radio bearer being one of the multiple radio bearers; and in step 104, transmits a data unit of the first radio bearer via the at least first RLC bearer as a response to receiving the third message; herein, the second message is an RRC layer signaling, while the third message is a signaling of a protocol layer below the RRC layer.

In one embodiment, a first message is received through an air interface.

In one embodiment, the air interface is a Uu air interface.

In one embodiment, the air interface is a PC5 air interface.

In one embodiment, the first message is an upper-layer message.

In one embodiment, the first message is a Radio Resource Control (RRC) signaling.

In one embodiment, the first message is comprised in a CellGroupConfig message.

In one embodiment, the first message comprises all or part of Information Elements (IEs) in an RRC signaling.

In one embodiment, the first message comprises all or part of fields of an IE in an RRC signaling.

In one embodiment, the first message is an IE in Cell Group (CG) configuration.

In one embodiment, the first message is used for configuring at least first RLC bearer.

In one embodiment, the at least first RLC bearer only comprises a first RLC bearer.

In one embodiment, the at least first RLC bearer comprises multiple RLC bearers, with the first RLC bearer being one of the multiple RLC bearers.

In one embodiment, the first message is comprised in a rlc-BearerToAddModList message.

In one embodiment, the first message is an RLC-BearerConfig.

In one embodiment, the first message comprises configuration(s) of the at least first RLC bearer.

In one embodiment, the configuration of an RLC bearer comprises a lower layer part of a radio bearer configuration, which includes RLC and logical channel configuration.

In one embodiment, the configuration(s) of the at least first RLC bearer include configuration(s) of at least a first logical channel, the at least said first logical channel respectively corresponding to the at least first RLC bearer, and both the at least said first logical channel and the at least first RLC bearer being identified by at least a first Logical Channel Identifier (LCID), where the configuration(s) of the at least first RLC bearer include the at least said first LCID.

In one embodiment, the configuration(s) of the at least said first logical channel include priority/priorities of the at least said first logical channel.

In one embodiment, the configuration(s) of the at least first RLC bearer include configuration(s) of at least a first RLC entity, the at least first RLC entity respectively corresponding to the at least first RLC bearer, where the at least first RLC entity is/are used for transmitting data unit(s) of the at least first RLC bearer.

In one embodiment, the configuration(s) of the at least first RLC entity include the working mode of the at least first RLC entity.

In one embodiment, each logical channel of the at least said first logical channel is associated with an RLC entity of the at least first RLC entity.

In one embodiment, a logical channel being associated with an RLC entity means: an RLC entity conveying/receiving data to/from lower layers through a logical channel.

In one embodiment, a second message is received through the air interface.

In one embodiment, the second message is a higher-layer message.

In one embodiment, the second message is a Radio Resource Control (RRC) signaling.

In one embodiment, the second message is comprised in a CellGroupConfig message.

In one embodiment, the second message comprises all or part of Information Elements (IEs) in an RRC signaling.

In one embodiment, the second message comprises all or part of fields of an IE in an RRC signaling.

In one embodiment, the second message is an IE in Cell Group (CG) configuration.

In one embodiment, the first message and the second message belong to a same RRC signaling.

In one embodiment, the first message and the second message belong to two IEs in a same RRC signaling.

In one embodiment, the first message and the second message belong to two fields of a same IE in a same RRC signaling.

In one embodiment, the second message indicates that the at least first RLC bearer is/are a candidate of multiple radio bearers.

In one embodiment, a name of the second message includes reserved.

In one embodiment, a name of the second message includes candidate.

In one embodiment, a name of the second message includes reservedRLCBearer-Config.

In one embodiment, a name of the second message includes candidateRLCBearer-Config.

In one embodiment, the second message comprises the at least said first LCID, where each logical channel identifier of the at least said first LCID identifies one RLC bearer of the at least first RLC bearer.

In one embodiment, the second message comprises multiple radio bearer identifiers, where each radio bearer identifier among the multiple radio bearer identifiers is used for identifying one of the multiple radio bearers.

In one embodiment, the multiple radio bearer identifiers are used for identifying the multiple radio bearers, with the multiple radio bearer identifiers respectively corresponding to the multiple radio bearers.

In one embodiment, the second message comprises a CandidateRadioBearer field, the CandidateRadioBearer field comprising the multiple radio bearer identifiers.

In one embodiment, the multiple radio bearers include a Data Radio Bearer (DRB).

In one embodiment, the multiple radio bearers include an MBS Radio Bearer (MRB).

In one embodiment, the multiple radio bearers include a multicast MRB.

In one embodiment, the multiple radio bearers include a Signaling Radio Bearer (SRB).

In one embodiment, the multiple radio bearers belong to a same Protocol Data Unit (PDU) session.

In one embodiment, the multiple radio bearers belong to different PDU sessions.

In one embodiment, the multiple radio bearers belong to different PDU sets.

In one embodiment, the different PDU sets belong to a same application.

In one embodiment, the different PDU sets belong to a same session.

In one embodiment, the phrase that the at least first RLC bearer is/are a candidate of multiple radio bearers comprises that: the at least first RLC bearer is/are configured (by the third message) to be used only for lower-layer transmissions of the multiple radio bearers.

In one embodiment, the phrase that the at least first RLC bearer is/are a candidate of multiple radio bearers comprises that: the at least first RLC bearer cannot be configured to be used for lower-layer transmission of any radio bearer other than the multiple radio bearers.

In one embodiment, the phrase that the at least first RLC bearer is/are a candidate of multiple radio bearers comprises that: the at least first RLC bearer is/are configured (by the third message) to be associated with any radio bearer among the multiple radio bearers.

In one embodiment, the phrase that the at least first RLC bearer is/are a candidate of multiple radio bearers comprises that: each of the at least first RLC bearer is configured (by the third message) to be associated with any radio bearer among the multiple radio bearers.

In one embodiment, the phrase that the at least first RLC bearer is/are a candidate of multiple radio bearers comprises that: each of the at least first RLC bearer is configured (by the third message) to be associated with a different radio bearer among the multiple radio bearers.

In one embodiment, the phrase that the at least first RLC bearer is/are a candidate of multiple radio bearers comprises that: the at least first RLC bearer cannot be configured to be associated with any radio bearer other than the multiple radio bearers.

In one embodiment, the phrase that the at least first RLC bearer is/are a candidate of multiple radio bearers comprises that: before being configured (by the third message) to be associated with any radio bearer among the multiple radio bearers, the at least first RLC bearer is/are in deactivated state.

In one embodiment, a third message is received through the air interface.

In one embodiment, the third message is a signaling of a protocol layer below an RRC layer.

In one embodiment, the method above can lead to fast radio bearer reconfiguration.

In one embodiment, the third message is a Packet Data Convergence Protocol (PDCP) sublayer signaling.

In one embodiment, the third message is an RLC sublayer signaling.

In one embodiment, the third message is a Medium Access Control (MAC) sublayer signaling.

In one embodiment, the third message is a MAC Control Element (CE).

In one embodiment, the third message is carried in a MAC subheader.

In one embodiment, the third message is a PHY layer signaling.

In one embodiment, a name of the third message includes activation.

In one embodiment, a name of the third message is Candidate RLC Activation.

In one embodiment, a name of the third message is Candidate RLC Activation/Deactivation.

In one embodiment, the third message indicates that the at least first RLC bearer is/are associated with a first radio bearer.

In one embodiment, the third message comprises a first radio bearer identifier, the first radio bearer identifier for identifying the first radio bearer.

In one embodiment, the third message comprises the at least said first LCID and a first radio bearer identifier, with the at least said first LCID being used for identifying the at least first RLC bearer; the first radio bearer identifier is used for identifying the first radio bearer.

In one embodiment, the first radio bearer is one of the multiple radio bearers, and the first radio bearer identifier is one of the multiple radio bearer identifiers.

In one embodiment, when an RLC bearer is configured to serve one radio bearer, the RLC bearer is associated with the radio bearer.

In one embodiment, when a radio bearer is configured to be transmitted via an RLC bearer in lower layers, the RLC bearer is associated with the radio bearer.

In one embodiment, the lower layers include an RLC sublayer.

In one embodiment, the lower layers include a logical channel.

In one embodiment, the lower layers include a MAC sublayer.

In one embodiment, each RLC bearer of the at least first RLC bearer is associated with the first radio bearer.

In one embodiment, the phrase that the at least first RLC bearer is/are associated with a first radio bearer comprises that: the at least first RLC bearer is/are associated with a first radio bearer and is/are activated.

In one embodiment, the phrase that the at least first RLC bearer is/are associated with a first radio bearer comprises that: when the at least first RLC bearer includes only the first RLC bearer, the first RLC bearer is activated.

In one embodiment, the phrase that the at least first RLC bearer is/are associated with a first radio bearer comprises that: when the at least first RLC bearer include multiple RLC bearers, at least one of the multiple RLC bearers is activated.

In one embodiment, when an RLC entity is activated, an RLC bearer that comprises the RLC entity is activated.

In one embodiment, transmitting a data unit of the first radio bearer via the at least first RLC bearer as a response to receiving the third message.

In one embodiment, transmitting a data unit of the first radio bearer via one of the at least first RLC bearer as a response to receiving the third message; herein, the at least first RLC bearer include multiple RLC bearers.

In one subembodiment, one of the at least first RLC bearer is an RLC bearer corresponding to a logical channel with a smallest LCID.

In one subembodiment, one of the at least first RLC bearer is an RLC bearer corresponding to a logical channel with a largest LCID.

In one subembodiment, one of the at least first RLC bearer is an RLC bearer corresponding to a reference logical channel, where the RLC bearer corresponding to the reference logical channel belongs to the at least first RLC bearer, the reference logical channel being indicated by the second message or the third message.

In one embodiment, transmitting a data unit of the first radio bearer via each of the at least first RLC bearer as a response to receiving the third message; herein, the at least first RLC bearer include multiple RLC bearers.

In one embodiment, the word transmitting includes at least one of sending or receiving.

In one embodiment, any data unit processed by an RLC entity corresponding to the at least first RLC bearer in the downlink is delivered to a PDCP entity of the first radio bearer.

In one subembodiment, the PDCP entity is a receiving PDCP entity.

In one embodiment, any data unit processed by a PDCP entity of the first radio bearer in the uplink is delivered to an RLC entity corresponding to the at least first RLC bearer.

In one subembodiment, the PDCP entity is a transmitting PDCP entity.

In one embodiment, the data unit comprises an Internet Protocol (IP) data packet.

In one embodiment, the data unit comprises a Non-access stratum (NAS) control message.

In one embodiment, the data unit comprises an RRC signaling.

In one embodiment, the data unit comprises a Service Data Unit (SDU).

### Embodiment 2

Embodiment 2 illustrates a schematic diagram of a network architecture according to one embodiment of the present application, as shown in FIG. 2. FIG. 2 illustrates a network architecture 200 of NR 5G, Long-Term Evolution (LTE), and Long-Term Evolution Advanced (LTE-A) systems. The NR 5G or LTE, or LTE-A network architecture 200 may be called a 5G System/Evolved Packet System (5GS/EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server/Unified Data Management (HSS/UDM) 220 and an Internet Service 230. The 5GS/EPS may be interconnected with other access networks. For simple description, the entities/interfaces are not shown. As shown in FIG. 2, the 5GS/EPS provides packet switching services. Those skilled in the art will find it easy to understand that various concepts presented throughout the present application can be extended to networks providing circuit switching services or other cellular networks. The NG-RAN comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The XnAP protocol for the Xn interface is used for transmitting control-plane messages of the wireless network, while the user-plane protocol for the Xn interface is used for transmitting user-plane data. The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. In NTN, the gNB 203 can be a satellite, an aircraft or a terrestrial base station relayed through the satellite. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, vehicle-mounted equipment, vehicle-mounted communication units, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises operator-compatible IP services, specifically including Internet, Intranet, IP Multimedia Subsystem (IMS) and Packet Switching (PS) Streaming services.

In one embodiment, the UE 201 corresponds to a first node in the present application.

In one embodiment, the gNB203 corresponds to a second node in the present application.

In one embodiment, the UE 201 is a User Equipment (UE).

In one embodiment, the UE 201 is a Layer 2 (L2) U2N remote UE.

In one embodiment, the gNB203 is a Macro Cell base station.

In one embodiment, the gNB203 is a Micro Cell base station.

In one embodiment, the gNB203 is a Pico Cell base station.

In one embodiment, the gNB203 is a Femtocell.

In one embodiment, the gNB203 is a base station supporting large time-delay difference.

In one embodiment, the gNB203 is a flight platform.

In one embodiment, the gNB203 is satellite equipment.

In one embodiment, the gNB203 is a base station supporting large time-delay difference.

In one embodiment, the gNB203 is a piece of test equipment (e.g., a transceiving device simulating partial functions of the base station, or a signaling test instrument).

In one embodiment, a radio link from the UE201 to the gNB203 is an uplink, the uplink being used for performing uplink transmission.

In one embodiment, a radio link from the gNB203 to the UE201 is a downlink, the downlink being used for performing downlink transmission.

In one embodiment, the UE201 and the gNB203 are connected by a Uu air interface.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 of a UE and a gNB is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection, and also support for handover of a UE between gNBs. The RLC sublayer 303 provides segmentation and reassembling of a packet, retransmission of a lost packet through an Automatic Repeat Request (ARQ), and detection of duplicate packets and protocol errors. The MAC sublayer 302 provides mappings between a logical channel and a transport channel as well as multiplexing of logical channels. The MAC sublayer 302 is also responsible for allocating between UEs various radio resources (i.e., resource block) in a cell. The MAC sublayer 302 is also in charge of Hybrid Automatic Repeat Request (HARQ) operation. In the control plane 300, The Radio Resource Control (RRC) sublayer 306 in the L3 layer is responsible for acquiring radio resources (i.e., radio bearer) and configuring the lower layer using an RRC signaling between the gNB and the UE. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between Quality of Service (QoS) streams and a Data Radio Bearer (DRB), so as to support diversified traffics. The radio protocol architecture of UE in the user plane 350 may comprise all or part of protocol sublayers of a SDAP sublayer 356, a PDCP sublayer 354, a RLC sublayer 353 and a MAC sublayer 352 in L2. Although not described in FIG. 3, the UE may comprise several higher layers above the L2 355, such as a network layer (i.e., IP layer) terminated at a P-GW of the network side and an application layer terminated at the other side of the connection (i.e., a peer UE, a server, etc.).

In one embodiment, the RLC303 transmits/receives data to/from the MAC302 via the logical channel.

In one embodiment, the RLC353 transmits/receives data to/from the MAC352 via the logical channel.

In one embodiment, the RLC303 and the logical channel for communications between the RLC303 and the MAC 302 form an RLC bearer.

In one embodiment, the RLC353 and the logical channel for communications between the RLC353 and the MAC 352 form an RLC bearer.

In one embodiment, entities of multiple sublayers of the control plane in FIG. 3 form an SRB vertically.

In one embodiment, entities of multiple sublayers of the user plane in FIG. 3 form a DRB vertically.

In one embodiment, entities of multiple sublayers of the user plane in FIG. 3 form an MRB vertically.

In one embodiment, the radio protocol architecture in FIG. 3 is applicable to a first node in the present application.

In one embodiment, the radio protocol architecture in FIG. 3 is applicable to a second node in the present application.

In one embodiment, the first message in the present application is generated by the RRC306.

In one embodiment, the second message in the present application is generated by the RRC306.

In one embodiment, the third message in the present application is generated by the PDCP304 or the PDCP354.

In one embodiment, the third message in the present application is generated by the RLC303 or the RLC353.

In one embodiment, the third message in the present application is generated by the MAC302 or the MAC352.

In one embodiment, the third message in the present application is generated by the PHY301 or the PHY351.

In one embodiment, the fourth message in the present application is generated by the RRC306.

In one embodiment, the fifth message in the present application is generated by the RRC306.

In one embodiment, a data unit set of the first radio bearer in the present application is generated by the PDCP304 or the PDCP354.

In one embodiment, the L2 305 or 355 belongs to a higher layer.

In one embodiment, the RRC sublayer 306 in the L3 belongs to a higher layer.

### Embodiment 4

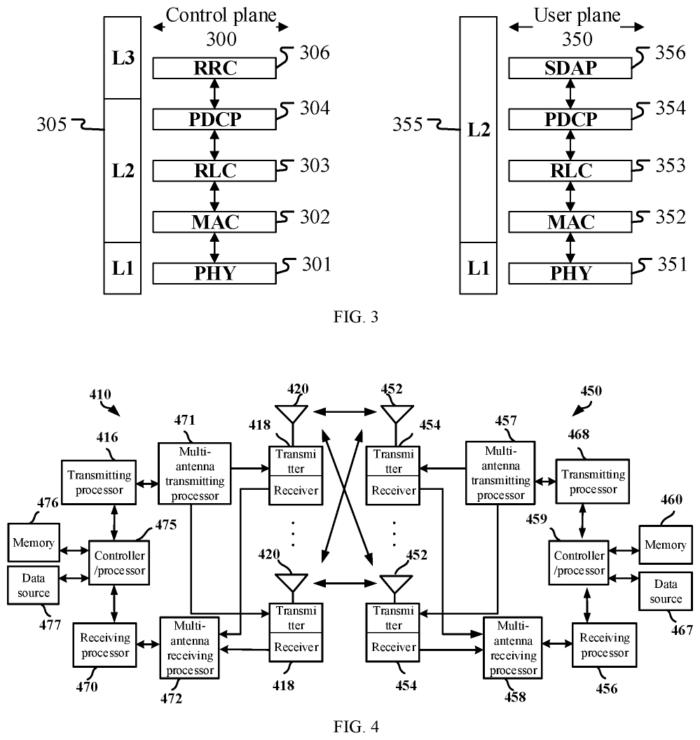

Embodiment 4 illustrates a schematic diagram of hardcore modules in a communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a data source 477, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network or from a data source 477 is provided to the controller/processor 475. The core network and data source 477 represents all protocol layers above the L2 layer. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In a transmission from the second communication device 410 to the first communication device 450, the controller/processor 459 provides multiplexing between a transport channel and a logical channel, packet reassembling, decrypting, header decompression, control signal processing so as to recover a higher-layer packet from the second communication device 410. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device 450. The higher-layer packet coming from the controller/processor 475 may be provided to the core network, or all protocol layers above the L2, or, various control signals can be provided to the core network or L3 for processing.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: receives a first message, the first message configuring at least first RLC bearer; and receives a second message, the second message indicating that the at least first RLC bearer is/are a candidate of multiple radio bearers; and receives a third message, the third message indicating that the at least first RLC bearer is/are associated with a first radio bearer, the first radio bearer being one of the multiple radio bearers; and transmits a data unit of the first radio bearer via the at least first RLC bearer as a response to receiving the third message; herein, the second message is an RRC layer signaling, while the third message is a signaling of a protocol layer below the RRC layer.

In one embodiment, the first communication device 450 comprises a memory that stores a computer readable instruction program, the computer readable instruction program generates actions when executed by at least one processor, which include: receiving a first message, the first message configuring at least first RLC bearer; and receiving a second message, the second message indicating that the at least first RLC bearer is/are a candidate of multiple radio bearers; and receiving a third message, the third message indicating that the at least first RLC bearer is/are associated with a first radio bearer, the first radio bearer being one of the multiple radio bearers; and transmitting a data unit of the first radio bearer via the at least first RLC bearer as a response to receiving the third message; herein, the second message is an RRC layer signaling, while the third message is a signaling of a protocol layer below the RRC layer.

In one embodiment, the second communication device 410 comprises at least one processor and at least one memory, the at least one memory comprises computer program codes; the at least one memory and the computer program codes are configured to be used in collaboration with the at least one processor. The second communication device 410 at least: transmits a first message, the first message configuring at least first RLC bearer; and transmits a second message, the second message indicating that the at least first RLC bearer is/are a candidate of multiple radio bearers; and transmits a third message, the third message indicating that the at least first RLC bearer is/are associated with a first radio bearer, the first radio bearer being one of the multiple radio bearers; and transmits a data unit of the first radio bearer via the at least first RLC bearer after transmitting the third message; herein, the second message is an RRC layer signaling, while the third message is a signaling of a protocol layer below the RRC layer.

In one embodiment, the second communication device 410 comprises a memory that stores a computer readable instruction program, the computer readable instruction program generates actions when executed by at least one processor, which include: transmitting a first message, the first message configuring at least first RLC bearer; and transmitting a second message, the second message indicating that the at least first RLC bearer is/are a candidate of multiple radio bearers; and transmitting a third message, the third message indicating that the at least first RLC bearer is/are associated with a first radio bearer, the first radio bearer being one of the multiple radio bearers; and transmitting a data unit of the first radio bearer via the at least first RLC bearer after transmitting the third message; herein, the second message is an RRC layer signaling, while the third message is a signaling of a protocol layer below the RRC layer.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a L2 U2N remote UE.

In one embodiment, the first communication device 450 is a L3 relay node.

In one embodiment, the second communication device 410 is a base station.

In one embodiment, at least one of the antenna 420, the transmitter 418, the multi-antenna transmitting processor 471, the transmitting processor 416 or the controller/processor 475 is used for transmitting a first message in the present application.

In one embodiment, at least one of the antenna 452, the receiver 454, the multi-antenna receiving processor 458, the receiving processor 456 or the controller/processor 459 is used for receiving a first message in the present application.

In one embodiment, at least one of the antenna 420, the transmitter 418, the multi-antenna transmitting processor 471, the transmitting processor 416 or the controller/processor 475 is used for transmitting a second message in the present application.

In one embodiment, at least one of the antenna 452, the receiver 454, the multi-antenna receiving processor 458, the receiving processor 456 or the controller/processor 459 is used for receiving a second message in the present application.

In one embodiment, at least one of the antenna 420, the transmitter 418, the multi-antenna transmitting processor 471, the transmitting processor 416 or the controller/processor 475 is used for transmitting a third message in the present application.

In one embodiment, at least one of the antenna 452, the receiver 454, the multi-antenna receiving processor 458, the receiving processor 456 or the controller/processor 459 is used for receiving a third message in the present application.

In one embodiment, at least one of the antenna 452, the transmitter 454, the multi-antenna transmitting processor 457, the transmitting processor 468 or the controller/processor 459 is used for transmitting a fourth message in the present application.

In one embodiment, at least one of the antenna 420, the receiver 418, the multi-antenna receiving processor 472, the receiving processor 470 or the controller/processor 475 is used for receiving a fourth message in the present application.

In one embodiment, at least one of the antenna 420, the transmitter 418, the multi-antenna transmitting processor 471, the transmitting processor 416 or the controller/processor 475 is used for transmitting a fifth message in the present application.

In one embodiment, at least one of the antenna 452, the receiver 454, the multi-antenna receiving processor 458, the receiving processor 456 or the controller/processor 459 is used for receiving a fifth message in the present application.

In one embodiment, at least one of the antenna 452, the transmitter 454, the multi-antenna transmitting processor 457, the transmitting processor 468 or the controller/processor 459 is used for transmitting a data unit of a first radio bearer in the present application.

In one embodiment, at least one of the antenna 452, the receiver 454, the multi-antenna receiving processor 458, the receiving processor 456 or the controller/processor 459 is used for receiving a data unit of a first radio bearer in the present application.

In one embodiment, at least one of the antenna 420, the receiver 418, the multi-antenna receiving processor 472, the receiving processor 470 or the controller/processor 475 is used for receiving a data unit of a first radio bearer in the present application.

In one embodiment, at least one of the antenna 420, the transmitter 418, the multi-antenna transmitting processor 471, the transmitting processor 416 or the controller/processor 475 is used for transmitting a data unit of a first radio bearer in the present application.

### Embodiment 5

Embodiment 5 illustrates a flowchart of a radio signal transmission according to one embodiment of the present application, as shown in FIG. 5. In FIG. 5, a first node N51 and a second node N52 are in communication via an air interface. It should be particularly noted that the sequence illustrated herein does not set any limit to the signal transmission order or implementation order in the present application. Steps marked by the dotted-line box F50 are optional.

The first node N51 receives a fifth message in step S511; and associates a second RLC bearer with a first radio bearer in step S512; receives a first message in step S513; receives a second message in step S514; transmits a fourth message in step S515; and receives a third message in step S516; associates at least first RLC bearer with a first radio bearer in step S517; and transmits a data unit of the first radio bearer via at least the first RLC bearer in step S518.

The second node N52 transmits a fifth message in step S521; transmits a first message in step S522; and transmits a second message in step S523; receives a fourth message in step S524; and transmits a third message in step S525.

It should be noted that the step S518 comprises at least one of transmitting a data unit of a first radio bearer via at least first RLC bearer or receiving a data unit of the first radio bearer via the at least first RLC bearer.

It should be noted that the step S518 comprises communications between the first node N51 and the second node N52.

In Embodiment 5, receiving a first message, the first message configuring at least first RLC bearer; and receiving a second message, the second message indicating that the at least first RLC bearer is/are a candidate of multiple radio bearers; and receiving a third message, the third message indicating that the at least first RLC bearer is/are associated with a first radio bearer, the first radio bearer being one of the multiple radio bearers; and transmitting a data unit of the first radio bearer via the at least first RLC bearer as a response to receiving the third message; herein, the second message is an RRC layer signaling, while the third message is a signaling of a protocol layer below the RRC layer; transmitting a fourth message, the fourth message indicating a state of the first radio bearer; herein, the fourth message is used for triggering the third message; receiving a fifth message, the fifth message configuring a second RLC bearer to be associated with the first radio bearer; and transmitting a data unit of the first radio bearer via the second RLC bearer as a response to receiving the fifth message; herein, the fifth message is an RRC layer message; reception of the fifth message is earlier than reception of the third message; an RLC mode used by the said first RLC bearer being identical to an RLC mode used by the second RLC bearer.

In one embodiment, the second node N52 is a maintenance base station for a serving cell of the first node N51.

In one embodiment, the second node N52 is a Transmit/Receive Point (TRP) of a serving cell of the first node N51.

In one embodiment, the second node N52 is a maintenance base station for a master cell group (MCG) of the first node N51.

In one embodiment, the second node N52 is a maintenance base station for a Secondary cell group (SCG) of the first node N51.

In one embodiment, the second node N52 is a maintenance base station for a primary cell (PCell) of the first node N51.

In one embodiment, the second node N52 is a maintenance base station for a secondary cell (SCell) of the first node N51.

In one embodiment, the second node N52 is a maintenance base station for a special cell (SpCell) of the first node N51.

In one embodiment, receiving a fifth message, the fifth message configuring a second RLC bearer to be associated with the first radio bearer.

In one embodiment, the fifth message is a higher-layer message.

In one embodiment, the fifth message is an RRC layer message.

In one embodiment, the fifth message comprises all or part of Information Elements (IEs) in an RRC signaling.

In one embodiment, the fifth message comprises all or part of fields in an Information Element (IE) in an RRC signaling.

In one embodiment, the fifth message is an IE in Cell Group (CG) configuration.

In one embodiment, the fifth message indicates that the second RLC bearer is associated with the first radio bearer.

In one embodiment, the phrase that the second RLC bearer is associated with the first radio bearer comprises that: the second RLC bearer is associated with the first radio bearer and is activated.

In one embodiment, a name of the fifth message is RLC-BearerConfig.

In one embodiment, the fifth message comprises a second LCID, the second LCID identifying a second logical channel and the second RLC bearer, with the second logical channel corresponding to the second RLC bearer.

In one embodiment, the fifth message comprises a servedRadioBearer field; the servedRadioBearer field comprises the first radio bearer identifier, the first radio bearer identifier used for identifying the first radio bearer.

In one embodiment, the fifth message comprises configuration of a second RLC entity, the second RLC entity corresponding to the second RLC bearer, and the second RLC entity being used for transmitting a data unit of the second RLC bearer.

In one embodiment, the at least first RLC entity and the second RLC entity are both in an RLC sublayer of the first node.

In one embodiment, transmitting a data unit of the first radio bearer via the second RLC bearer as a response to receiving the fifth message.

In one embodiment, reception of the fifth message is earlier than reception of the third message.

In one embodiment, transmitting a fourth message, the fourth message indicating a state of the first radio bearer.

In one embodiment, the fourth message indicates a state of uplink transmission of the first radio bearer.

In one embodiment, the fourth message indicates a state of downlink transmission of the first radio bearer.

In one embodiment, the fourth message is a higher-layer message.

In one embodiment, the fourth message is an RRC layer message.

In one embodiment, the fourth message comprises all or part of Information Elements (IEs) in an RRC signaling.

In one embodiment, the fourth message comprises all or part of fields in an Information Element (IE) in an RRC signaling.

In one embodiment, the fourth message is used for indicating UE assistance information to the network.

In one embodiment, the fourth message is UEAssistanceInformation.

In one embodiment, the fourth message is used for indicating a failure message to the network.

In one embodiment, the fourth message is used for indicating an RLC failure message to the network.

In one embodiment, the fourth message is FailureInformation.

In one embodiment, the fourth message is MCGFailureInformation.

In one embodiment, the fourth message is SCGFailureInformation.

In one embodiment, the fourth message comprises the first radio bearer identifier.

In one embodiment, the fourth message explicitly indicates the state of the first radio bearer.

In one subembodiment, the state of the first radio bearer includes the at least first RLC bearer.

In one embodiment, the fourth message implicitly indicates the state of the first radio bearer.

In one embodiment, the state of the first radio bearer includes that the second RLC bearer associated with the first radio bearer is failed.

In one embodiment, the state of the first radio bearer includes that a maximum retransmission number of an RLC entity corresponding to the second RLC bearer associated with the first radio bearer is equal to a first threshold.

In one embodiment, a maximum retransmission number of an RLC entity corresponding to the second RLC bearer being equal to the first threshold is not used for triggering a Radio Link Failure (RLF).

In one embodiment, the state of the first radio bearer includes that a buffered data volume of the first radio bearer is no smaller than a second threshold.

In one embodiment, a buffered data volume of the first radio bearer comprises a summation of a data volume in a first PDCP entity and an RLC data volume waiting for initial transmission in the second RLC entity. herein, the first PDCP entity is associated with the first radio bearer.

In one embodiment, the state of the first radio bearer includes that a delay budget for a data unit of the first radio bearer is smaller than a third threshold.

In one embodiment, a delay budget for a data unit of the first radio bearer is a longest waiting time for the first node before a data unit of the first radio bearer is transmitted.

In one embodiment, the state of the first radio bearer includes Quality of Service (QoS) configuration profile of the first radio bearer.

In one embodiment, the first threshold is network-configured, or pre-configured.

In one embodiment, the second threshold is network-configured, or pre-configured.

In one embodiment, the third threshold is network-configured, or pre-configured.

In one embodiment, the fourth message is used for triggering the third message.

In one embodiment, by making the UE report messages and the network reconfigure radio bearers the above method can enhance the adaptability to the change of traffics and transmission channels.

In one embodiment, an RLC mode used by the at least first RLC bearer is identical to an RLC mode used by the second RLC bearer.

In one embodiment, the RLC mode includes Uplink (UL) RLC or Downlink (DL) RLC.

In one embodiment, the RLC mode includes one of Acknowledged Mode (AM) RLC, Unacknowledged Mode (UM) RLC or Transparent Mode (TM) RLC.

In one embodiment, an RLC mode used by the at least first RLC bearer is different from an RLC mode used by the second RLC bearer.

In one embodiment, configuration(s) of the at least first RLC bearer is/are identical to configuration of the second RLC bearer; herein, the third message only indicates a logical channel identifier (LCID) of the at least first RLC bearer.

In one embodiment, the at least first RLC bearer shares/share a same priority with the second RLC bearer.

In one embodiment, the at least first RLC bearer has/have a same allowed serving cell as the second RLC bearer.

In one embodiment, the serving cell is a primary serving cell.

In one embodiment, the serving cell is a secondary serving cell.

In one embodiment, the serving cell belongs to a primary serving cell group.

In one embodiment, the serving cell belongs to a secondary serving cell group.

In one embodiment, the at least first RLC bearer is/are of a different priority from the second RLC bearer.

In one embodiment, the at least first RLC bearer has/have a different allowed serving cell from the second RLC bearer.

In one subembodiment, the allowed serving cell of the second RLC bearer is a primary serving cell, while the allowed serving cell of the at least first RLC bearer is a secondary serving cell.

In one subembodiment, the allowed serving cell of the second RLC bearer is a secondary serving cell, while the allowed serving cell of the at least first RLC bearer is a primary serving cell.

In one subembodiment, the allowed serving cell of the second RLC bearer belongs to a primary serving cell group, while the allowed serving cell of the at least first RLC bearer belongs to a secondary serving cell group.

In one subembodiment, the allowed serving cell of the second RLC bearer belongs to a secondary serving cell group, while the allowed serving cell of the at least first RLC bearer belongs to a primary serving cell group.

In one embodiment, the at least said first logical channel and the second logical channel belong to a same Logical Channel Group (LCG).

In one embodiment, after receiving the fifth message and before receiving the third message, the first radio bearer is not configured with PDCP duplication nor configured with split bearer.

In one embodiment, after receiving the fifth message and before receiving the third message, the first radio bearer is only associated with the second RLC bearer.

In one embodiment, after receiving the fifth message and before receiving the third message, a data unit of the first radio bearer is transmitted only via the second RLC bearer.

In one embodiment, after receiving the fifth message and before receiving the third message, the first radio bearer has only one primary path for transmission.

In one embodiment, the PDCP duplication refers to Carrier Aggregation (CA) Duplication.

In one embodiment, after receiving the fifth message and before receiving the third message, the first radio bearer is configured with PDCP duplication.

In one embodiment, after receiving the fifth message and before receiving the third message, the first radio bearer is configured with split bearer.

### Embodiment 6

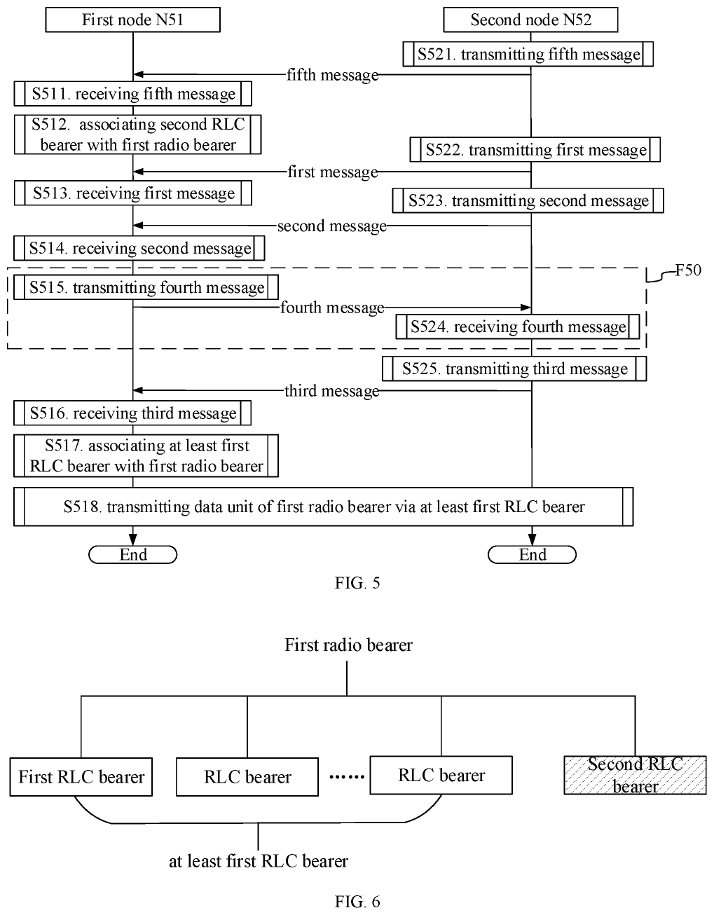

Embodiment 6 illustrates a schematic diagram of at least first RLC bearer, a second RLC bearer and a first radio bearer according to one embodiment of the present application, as shown in FIG. 6. In FIG. 6, the at least first RLC bearer include multiple RLC bearers, where the at least first RLC bearer and the second RLC bearer are associated with the first radio bearer; the slash-filled box represents a second RLC bearer which is deactivated.

In one embodiment, the third message is used for deactivating the second RLC bearer.

In one subembodiment, the second RLC bearer is still associated with the first radio bearer.

In one embodiment, the phrase of deactivating the second RLC bearer comprises: deactivating an RLC entity comprised by the second RLC bearer.

In one embodiment, the phrase of deactivating the second RLC bearer comprises: the second RLC bearer being no longer used for transmitting a data unit of the first radio bearer.

In one embodiment, after receiving the third message, the first radio bearer only transmits a data unit of the first radio bearer via the at least first RLC bearer.

In one embodiment, the third message, while indicating that the at least first RLC bearer is/are associated with the first radio bearer, implicitly indicates that the second RLC bearer is deactivated.

In one embodiment, when at least two RLC bearers among the at least said RLC bearers are activated, the third message is used for configuring PDCP duplication of the first radio bearer or the first radio bearer to be split bearer.

In one embodiment, the third message is used for implicitly indicating that the second RLC bearer is no longer associated with the first radio bearer.

In one embodiment, the third message, while indicating that the at least first RLC bearer is/are associated with the first radio bearer, implicitly indicates that the second RLC bearer is no longer associated with the first radio bearer.

### Embodiment 7

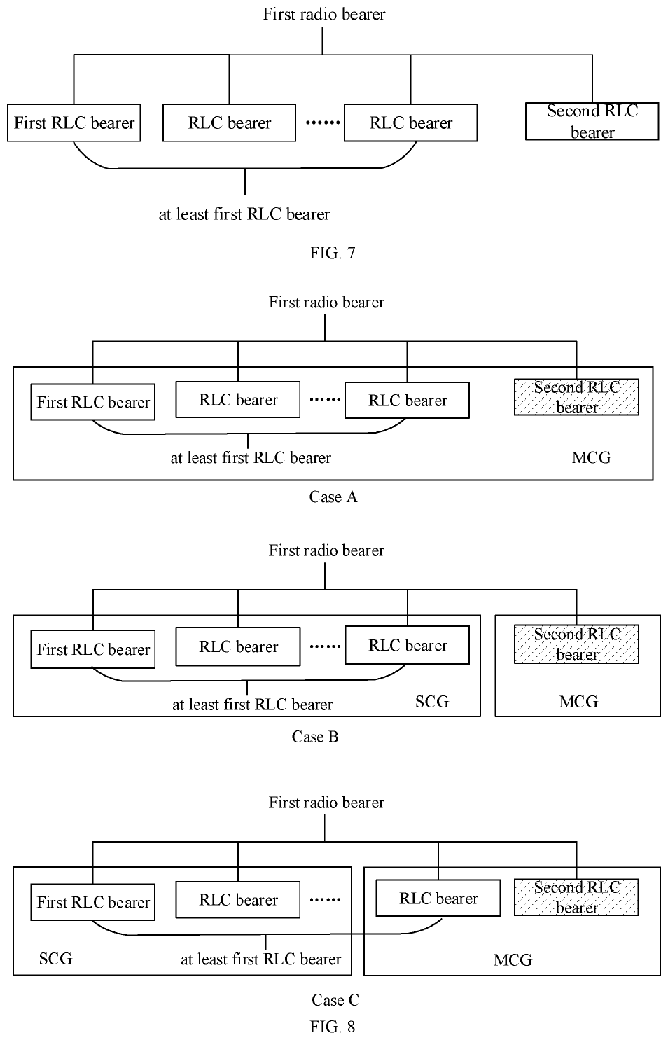

Embodiment 7 illustrates another schematic diagram of at least first RLC bearer, a second RLC bearer and a first radio bearer according to one embodiment of the present application, as shown in FIG. 7. In FIG. 7, the at least first RLC bearer include multiple RLC bearers, where the at least first RLC bearer and the second RLC bearer are associated with the first radio bearer.

Different from Embodiment 5, the third message is not used for deactivating the second RLC bearer.

In one embodiment, the third message is not used for deactivating an RLC entity comprised by the second RLC bearer.

In one embodiment, the third message indicates one of a PDCP duplication or a data volume threshold.

In one embodiment, an RLC entity comprised by the second RLC bearer is a primary RLC entity, while an RLC entity comprised by the at least first RLC entity is a secondary RLC entity.

In one embodiment, the at least first RLC bearer and the second RLC bearer are transmitted via a same MAC entity; herein, the third message indicates duplication.

In one embodiment, the at least first RLC bearer and the second RLC bearer are transmitted via different MAC entities; herein, the third message indicates a data volume threshold.

In one embodiment, the data volume threshold is used to determine whether a data unit of the first PDCP entity is delivered to the at least first RLC bearer or the second RLC bearer to be transmitted.

In one embodiment, the data volume threshold is used to determine whether a data unit of the first PDCP entity is delivered to the at least first RLC entity or the second RLC entity.

In one embodiment, when the third message indicates the PDCP duplication, the at least first RLC bearer and the second RLC bearer are used for PDCP duplication.

In one embodiment, when the third message indicates the PDCP duplication, PDCP duplication of the first radio bearer is activated.

In one embodiment, when the third message indicates the PDCP duplication, a PDCP data PDU is duplicated and delivered to the at least first RLC entity.

In one embodiment, when the third message indicates the PDCP duplication, a PDCP control PDU is only delivered to the second RLC entity.

In one embodiment, when the third message indicates the data volume threshold, the at least first RLC bearer is/are used for a splitSecondaryPath.

In one embodiment, when the third message indicates the data volume threshold, an RLC entity comprised by the at least first RLC bearer is a split secondary RLC entity.

In one embodiment, when the third message indicates the data volume threshold, the first radio bearer is activated in respect of a split bearer.

In one embodiment, when a summation of a data volume in the first PDCP entity and an RLC data volume waiting for initial transmission in the second RLC entity is no smaller than the data volume threshold, a PDCP PDU is delivered to any RLC entity of the at least first RLC entity and the second RLC entity.

In one embodiment, the third message indicates one of duplication or split bearer.

In one embodiment, when the third message indicates the split bearer, the at least first RLC bearer is/are used for a splitSecondaryPath.

It should be noted that the phrase “the at least first RLC bearer” in Embodiment 7 refers to “activated RLC bearer(s) among the at least first RLC bearer”.

### Embodiment 8

Embodiment 8 illustrates a schematic diagram of at least first RLC bearer, a second RLC bearer, a first radio bearer and a cell group according to one embodiment of the present application, as shown in FIG. 8. In FIG. 8, each blank box represents an RLC bearer of the at least first RLC bearer, and the slash-filled box represents a second RLC bearer.

In one embodiment, the at least first RLC bearer and the second RLC bearer belong to a same Cell Group (CG).

In one subembodiment, the cell group is a Master Cell Group (MCG).

In one subembodiment, the third message indicates duplication.

In one embodiment, the at least first RLC bearer and the second RLC bearer belong to different cell groups.

In one subembodiment, the at least first RLC bearer belongs/belong to a Secondary Cell Group (SCG), while the second RLC bearer belongs to a Master Cell Group (MCG).

In one embodiment, partial RLC bearers among the at least first RLC bearer and the second RLC bearer belong to different cell groups; herein, the at least first RLC bearer include multiple RLC bearers.

In one subembodiment, the partial RLC bearers among the at least first RLC bearer belong to an SCG, while the remaining RLC bearers among the at least first RLC bearer and the second RLC bearer belong to an MCG.

As depicted by Case A in FIG. 8, the at least first RLC bearer and the second RLC bearer belong to an MCG; as depicted by Case B in FIG. 8, the at least first RLC bearer belongs/belong to an SCG, while the second RLC bearer belongs to an MCG; as depicted by Case C in FIG. 8, one of the at least first RLC bearer and the second RLC bearer belong to an MCG, while the remaining of the at least first RLC bearer belong to an SCG.

In one embodiment, a maintenance base station for an MCG is a MgNB; a maintenance base station for an SCG is a SgNB.

### Embodiment 9

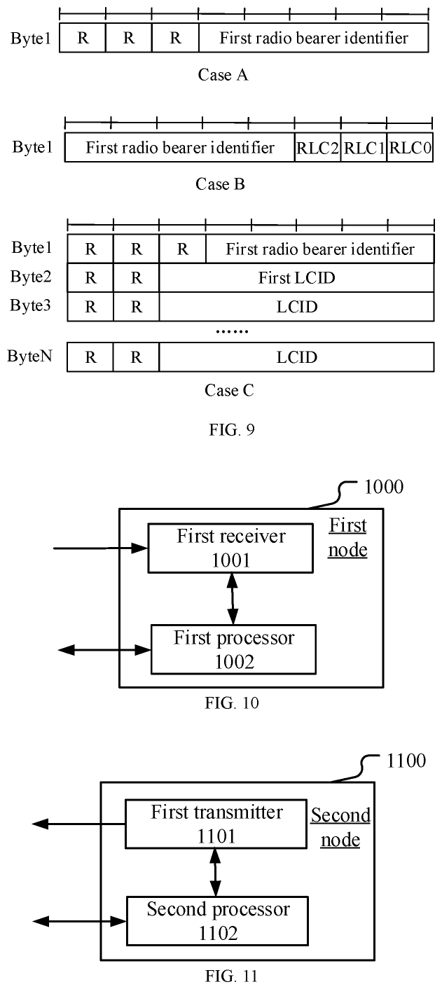

Embodiment 9 illustrates a schematic diagram of a format of a third message according to one embodiment of the present application, as shown in FIG. 9.

In one embodiment, the third message is a MAC CE.

In one embodiment, each RLC bearer of the at least first RLC bearer being associated with the first radio bearer is activated.

In one embodiment, the at least first RLC bearer being associated with the first radio bearer is/are activated.

In one embodiment, each activated RLC bearer of the at least first RLC bearer being associated with the first radio bearer is used for transmitting a data unit of the first radio bearer.

In one embodiment, each activated RLC bearer of the at least first RLC bearer being associated with the first radio bearer is used for PDCP duplication.

In one embodiment, each activated RLC bearer of the at least first RLC bearer being associated with the first radio bearer is used for a splitSecondaryPath.

In one embodiment, the third message only indicates the first radio bearer, and the third message implicitly indicates that each RLC bearer of the at least first RLC bearer being associated with the first radio bearer is activated; the third message implicitly indicates that the activated RLC bearer(s) is/are used for PDCP duplication.

In one embodiment, the third message indicates the first radio bearer and the data volume threshold, and the third message implicitly indicates that each RLC bearer of the at least first RLC bearer being associated with the first radio bearer is activated; the third message implicitly indicates that the activated RLC bearer(s) is/are used for a splitSecondaryPath.

In one embodiment, the third message indicates the first radio bearer and the at least first RLC bearer, where the at least first RLC bearer indicated by the third message is used for PDCP duplication.

In one embodiment, the third message indicates the first radio bearer, the at least first RLC bearer and the data volume threshold, where the at least first RLC bearer indicated by the third message is used for a splitSecondaryPath.

In one subembodiment of the above two embodiments, the third message indicates RLC bearer(s) being activated of the at least first RLC bearer.

In Case A of FIG. 9, the third message only indicates the first radio bearer; where lower 5 bits include a first radio bearer identifier; bit R included by higher 3 bits is reserved. Although not shown in Case A of FIG. 9, the reserved bit R included can also indicate a PDCP duplication or split bearer, for instance, with 0 indicating PDCP duplication while 1 indicating split bearer; when indicating the split bearer, the third message can also comprise one field for indicating a data volume threshold.

In Case B of FIG. 9, the third message indicates the first radio bearer, and indicates the at least first RLC bearer by a bitmap; In this bitmap, an RLC bearer indicated by each bit set to 1 is activated, while an RLC bearer indicated by each bit set to 0 is not activated; the bitmap from lowest bit to highest bit respectively correspond to RLC bearers indicated by LCIDs in an ascending order; Case B of FIG. 9 is applicable to instances when the number of RLC bearers among the at least first RLC bearer is no greater than 3. Although not shown in Case B of FIG. 9, the third message can also comprise a field indicating a PDCP duplication or split bearer, and, when indicating the split bearer, can further comprise a field indicating a data volume threshold.

In Case C of FIG. 9, the third message indicates the first radio bearer, and indicates the at least first RLC bearer by a LCID; the reserved bit R can indicate whether an RLC bearer indicated by a corresponding logical channel is activated, namely, the reserved bit R set to 1 indicates that an RLC bearer indicated by a corresponding logical channel is activated, while the reserved bit R set to 0 indicates that an RLC bearer indicated by a corresponding logical channel is not activated. Although not shown in Case C of FIG. 9, the reserved bit R included can also indicate a PDCP duplication or split bearer, for instance, with 0 indicating PDCP duplication while 1 indicating split bearer; when indicating the split bearer, the third message can also comprise one field for indicating a data volume threshold.

In one embodiment, the value of N in Case C of FIG. 9 is no greater than 32.

In one embodiment, the value of N in Case C of FIG. 9 is no greater than 65855.

### Embodiment 10

Embodiment 10 illustrates a structure block diagram of a processing device in a first node according to one embodiment of the present application, as shown in FIG. 10.

In FIG. 10, a processing device 1000 in the first node is comprised of a first receiver 1001 and a first processor 1002; the first node 1000 is a UE.

In Embodiment 10, the first receiver 1001 receives a first message, the first message configuring at least first RLC bearer; and receives a second message, the second message indicating that the at least first RLC bearer is/are a candidate of multiple radio bearers; and receives a third message, the third message indicating that the at least first RLC bearer is/are associated with a first radio bearer, the first radio bearer being one of the multiple radio bearers; and the first processor 1002 transmits a data unit of the first radio bearer via the at least first RLC bearer as a response to receiving the third message; herein, the second message is an RRC layer signaling, while the third message is a signaling of a protocol layer below the RRC layer.

In one embodiment, the first processor 1002 transmits a fourth message, the fourth message indicating a state of the first radio bearer; herein, the fourth message is used for triggering the third message.

In one embodiment, the first receiver 1001 receives a fifth message, the fifth message configuring a second RLC bearer to be associated with the first radio bearer; and the first processor 1002 transmits a data unit of the first radio bearer via the second RLC bearer as a response to receiving the fifth message; herein, the fifth message is an RRC layer message; reception of the fifth message is earlier than reception of the third message.

In one embodiment, the third message indicates one of a PDCP duplication or a data volume threshold; when the third message indicates the PDCP duplication, the at least first RLC bearer is/are used for PDCP duplication; when the third message indicates the data volume threshold, the at least first RLC bearer is/are used for a splitSecondaryPath.

In one embodiment, the first receiver 1001 receives a fifth message, the fifth message configuring a second RLC bearer to be associated with the first radio bearer; and the first processor 1002 transmits a data unit of the first radio bearer via the second RLC bearer as a response to receiving the fifth message; herein, the fifth message is an RRC layer message; reception of the fifth message is earlier than reception of the third message; the third message being used for deactivating the second RLC bearer.

In one embodiment, the first receiver 1001 receives a fifth message, the fifth message configuring a second RLC bearer to be associated with the first radio bearer; and the first processor 1002 transmits a data unit of the first radio bearer via the second RLC bearer as a response to receiving the fifth message; herein, the fifth message is an RRC layer message; reception of the fifth message is earlier than reception of the third message; an RLC mode used by the at least first RLC bearer being identical to an RLC mode used by the second RLC bearer.

In one embodiment, the first receiver 1001 receives a fifth message, the fifth message configuring a second RLC bearer to be associated with the first radio bearer; and the first processor 1002 transmits a data unit of the first radio bearer via the second RLC bearer as a response to receiving the fifth message; herein, the fifth message is an RRC layer message; reception of the fifth message is earlier than reception of the third message; the at least first RLC bearer and the second RLC bearer belonging to a same cell group, or, the at least first RLC bearer and the second RLC bearer belonging to different cell groups.

In one embodiment, the first receiver 1001 comprises the receiver 454 (comprising the antenna 452), the receiving processor 456, the multi-antenna receiving processor 458 and the controller/processor 459 in FIG. 4 of the present application.

In one embodiment, the first receiver 1001 comprises at least one of the receiver 454 (comprising the antenna 452), the receiving processor 456, the multi-antenna receiving processor 458 or the controller/processor 459 in FIG. 4 of the present application.

In one embodiment, the first processor 1002 comprises the receiver 454 (comprising the antenna 452), the receiving processor 456, the multi-antenna receiving processor 458 and the controller/processor 459 in FIG. 4 of the present application.

In one embodiment, the first processor 1002 comprises at least one of the receiver 454 (comprising the antenna 452), the receiving processor 456, the multi-antenna receiving processor 458 or the controller/processor 459 in FIG. 4 of the present application.

In one embodiment, the first processor 1002 comprises the transmitter 454 (comprising the antenna 452), the transmitting processor 468, the multi-antenna transmitting processor 457 and the controller/processor 459 in FIG. 4 of the present application.

In one embodiment, the first processor 1002 comprises at least one of the transmitter 454 (comprising the antenna 452), the transmitting processor 468, the multi-antenna transmitting processor 457 or the controller/processor 459 in FIG. 4 of the present application.

In one embodiment, the first processor 1002 comprises the controller/processor 459 in FIG. 4 of the present application.

### Embodiment 11

Embodiment 11 illustrates a structure block diagram of a processing device in a second node according to one embodiment of the present application, as shown in FIG. 11. In FIG. 11, a processing device 1100 in the second node comprises a first transmitter 1101 and a second processor 1102; the second node 1100 is a base station.

In Embodiment 11, the first transmitter 1101 transmits a first message, the first message configuring at least first RLC bearer; and transmits a second message, the second message indicating that the at least first RLC bearer is/are a candidate of multiple radio bearers; and transmits a third message, the third message indicating that the at least first RLC bearer is/are associated with a first radio bearer, the first radio bearer being one of the multiple radio bearers; and the second processor 1102 transmits a data unit of the first radio bearer via the at least first RLC bearer after transmitting the third message; herein, the second message is an RRC layer signaling, while the third message is a signaling of a protocol layer below the RRC layer.

In one embodiment, the second processor 1102 receives a fourth message, the fourth message indicating a state of the first radio bearer; herein, the fourth message is used for triggering the third message.

In one embodiment, the first transmitter 1101 transmits a fifth message, the fifth message configuring a second RLC bearer to be associated with the first radio bearer; and the second processor 1102 transmits a data unit of the first radio bearer via the second RLC bearer after transmitting the fifth message; herein, the fifth message is an RRC layer message; transmission of the fifth message is earlier than transmission of the third message.

In one embodiment, the third message indicates one of a PDCP duplication or a data volume threshold; when the third message indicates the PDCP duplication, the at least first RLC bearer is/are used for PDCP duplication; when the third message indicates the data volume threshold, the at least first RLC bearer is/are used for a splitSecondaryPath.

In one embodiment, the first transmitter 1101 transmits a fifth message, the fifth message configuring a second RLC bearer to be associated with the first radio bearer; and the second processor 1102 transmits a data unit of the first radio bearer via the second RLC bearer after transmitting the fifth message; herein, the fifth message is an RRC layer message; transmission of the fifth message is earlier than transmission of the third message; the third message being used for deactivating the second RLC bearer.

In one embodiment, the first transmitter 1101 transmits a fifth message, the fifth message configuring a second RLC bearer to be associated with the first radio bearer; and the second processor 1102 transmits a data unit of the first radio bearer via the second RLC bearer after transmitting the fifth message; herein, the fifth message is an RRC layer message; transmission of the fifth message is earlier than transmission of the third message; an RLC mode used by the at least first RLC bearer being identical to an RLC mode used by the second RLC bearer.

In one embodiment, the first transmitter 1101 transmits a fifth message, the fifth message configuring a second RLC bearer to be associated with the first radio bearer; and the second processor 1102 transmits a data unit of the first radio bearer via the second RLC bearer after transmitting the fifth message; herein, the fifth message is an RRC layer message; transmission of the fifth message is earlier than transmission of the third message; the at least first RLC bearer and the second RLC bearer belonging to a same cell group, or, the at least first RLC bearer and the second RLC bearer belonging to different cell groups.

In one embodiment, the first transmitter 1101 comprises the transmitter 418 (comprising the antenna 420), the transmitting processor 416, the multi-antenna transmitting processor 471 and the controller/processor 475 in FIG. 4 of the present application.

In one embodiment, the first transmitter 1101 comprises at least one of the transmitter 418 (comprising the antenna 420), the transmitting processor 416, the multi-antenna transmitting processor 471 or the controller/processor 475 in FIG. 4 of the present application.

In one embodiment, the second processor 1102 comprises the transmitter 418 (comprising the antenna 420), the transmitting processor 416, the multi-antenna transmitting processor 471 and the controller/processor 475 in FIG. 4 of the present application.

In one embodiment, the second processor 1102 comprises at least one of the transmitter 418 (comprising the antenna 420), the transmitting processor 416, the multi-antenna transmitting processor 471 or the controller/processor 475 in FIG. 4 of the present application.

In one embodiment, the second processor 1102 comprises the transmitter 418 (comprising the antenna 420), the receiving processor 470, the multi-antenna receiving processor 472 and the controller/processor 475 in FIG. 4 of the present application.

In one embodiment, the second processor 1102 comprises at least one of the transmitter 418 (comprising the antenna 420), the receiving processor 470, the multi-antenna receiving processor 472 or the controller/processor 475 in FIG. 4 of the present application.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first-type communication node or UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The second-type communication node or base station or network-side device in the present application includes but is not limited to macro-cellular base stations, micro-cellular base stations, home base stations, relay base station, eNB, gNB, Transmitter Receiver Point (TRP), relay satellite, satellite base station, airborne base station, test equipment like transceiving device simulating partial functions of base station or signaling tester and other radio communication equipment.

It will be appreciated by those skilled in the art that this application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, characterized in comprising:
a first receiver, which receives a first message, the first message configuring at least first RLC bearer; and receives a second message, the second message indicating that the at least first RLC bearer is/are a candidate of multiple radio bearers; and receives a third message, the third message indicating that the at least first RLC bearer is/are associated with a first radio bearer, the first radio bearer being one of the multiple radio bearers; and
a first processor, which transmits a data unit of the first radio bearer via the at least first RLC bearer as a response to receiving the third message;
wherein the second message is an RRC layer signaling, while the third message is a signaling of a protocol layer below the RRC layer.

2. The first node according to claim 1, characterized in comprising:
the first processor, which transmits a fourth message, the fourth message indicating a state of the first radio bearer;
wherein the fourth message is used for triggering the third message.

3. The first node according to claim 1, characterized in comprising:
the first receiver, which receives a fifth message, the fifth message configuring a second RLC bearer to be associated with the first radio bearer; and
the first processor, which transmits a data unit of the first radio bearer via the second RLC bearer as a response to receiving the fifth message;
wherein the fifth message is an RRC layer message; reception of the fifth message is earlier than reception of the third message.

4. The first node according to claim 1, characterized in that the third message indicates one of a Packet Data Convergence Protocol (PDCP) duplication or a data volume threshold; when the third message indicates the PDCP duplication, the at least first RLC bearer is/are used for PDCP duplication; when the third message indicates the data volume threshold, the at least first RLC bearer is/are used for a splitSecondaryPath.

5. The first node according to claim 3, characterized in that the third message is used for deactivating the second RLC bearer.

6. The first node according to claim 3, characterized in that an RLC mode used by the at least said RLC bearer is identical to an RLC mode used by the second RLC bearer.

7. The first node according to claim 3, characterized in that the at least first RLC bearer and the second RLC bearer belong to a same cell group, or, the at least first RLC bearer and the second RLC bearer belong to different cell groups.

8. A second node for wireless communications, characterized in comprising:
a first transmitter, which transmits a first message, the first message configuring at least first RLC bearer; and transmits a second message, the second message indicating that the at least first RLC bearer is/are a candidate of multiple radio bearers; and transmits a third message, the third message indicating that the at least first RLC bearer is/are associated with a first radio bearer, the first radio bearer being one of the multiple radio bearers; and
a second processor, which transmits a data unit of the first radio bearer via the at least first RLC bearer after transmitting the third message;
wherein the second message is an RRC layer signaling, while the third message is a signaling of a protocol layer below the RRC layer.

9. The second node according to claim 8, characterized in comprising:
the second processor, which receives a fourth message, the fourth message indicating a state of the first radio bearer;
wherein the fourth message is used for triggering the third message.

10. The second node according to claim 8, characterized in comprising:
the first transmitter, which transmits a fifth message, the fifth message configuring a second RLC bearer to be associated with the first radio bearer; and
the second processor, which transmits a data unit of the first radio bearer via the second RLC bearer after transmitting the fifth message;
wherein the fifth message is an RRC layer message; transmission of the fifth message is earlier than transmission of the third message.

11. The second node according to claim 8, characterized in that the third message indicates one of a PDCP duplication or a data volume threshold; when the third message indicates the PDCP duplication, the at least first RLC bearer is/are used for PDCP duplication; when the third message indicates the data volume threshold, the at least first RLC bearer is/are used for a splitSecondaryPath.

12. The second node according to claim 10, characterized in that the third message is used for deactivating the second RLC bearer.

13. The second node according to claim 10, characterized in that the at least first RLC bearer and the second RLC bearer belong to a same cell group, or, the at least first RLC bearer and the second RLC bearer belong to different cell groups.

14. A method in a first node for wireless communications, characterized in comprising:
receiving a first message, the first message configuring at least first RLC bearer; and
receiving a second message, the second message indicating that the at least first RLC bearer is/are a candidate of multiple radio bearers; and
receiving a third message, the third message indicating that the at least first RLC bearer is/are associated with a first radio bearer, the first radio bearer being one of the multiple radio bearers; and
transmitting a data unit of the first radio bearer via the at least first RLC bearer as a response to receiving the third message;
wherein the second message is an RRC layer signaling, while the third message is a signaling of a protocol layer below the RRC layer.

15. The method in the first node according to claim 14, characterized in comprising:
transmitting a fourth message, the fourth message indicating a state of the first radio bearer;
wherein the fourth message is used for triggering the third message.

16. The method in the first node according to claim 14, characterized in comprising:
receiving a fifth message, the fifth message configuring a second RLC bearer to be associated with the first radio bearer; and
transmitting a data unit of the first radio bearer via the second RLC bearer as a response to receiving the fifth message;
wherein the fifth message is an RRC layer message; reception of the fifth message is earlier than reception of the third message.

17. The method in the first node according to claim 14, characterized in that the third message indicates one of a PDCP duplication or a data volume threshold; when the third message indicates the PDCP duplication, the at least first RLC bearer is/are used for PDCP duplication; when the third message indicates the data volume threshold, the at least first RLC bearer is/are used for a splitSecondaryPath.

18. The method in the first node according to claim 16, characterized in that the third message is used for deactivating the second RLC bearer.

19. The method in the first node according to claim 16, characterized in that an RLC mode used by the at least first RLC bearer is identical to an RLC mode used by the second RLC bearer.

20. The method in the first node according to claim 16, characterized in that the at least first RLC bearer and the second RLC bearer belong to a same cell group, or, the at least first RLC bearer and the second RLC bearer belong to different cell groups.
